(19) United States
(12) Patent Application Publication
(10) Pub. No.: US 2008/0186608 A1
(43) Pub. Date: Aug. 7, 2008

(54) Method of testing a magnetic head

(75) Inventor: Hisato Arai, Kawasaki-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/001,896

(22) Filed: Dec. 13, 2007

(30) Foreign Application Priority Data
Feb. 2, 2007 (JP) 2007-23699

(51) Int. Cl. G11B 27/36

(52) U.S. Cl. 360/31

(57) ABSTRACT

A method of testing tests a magnetic head including a read element, a write element, and a predetermined electrical circuit. A magnetic signal on a magnetic recording medium is read using the read element in a state where the read element is subjected to noise due to electrical waves and an electric field induced by applying an AC bias voltage to the electrical circuit, and the output signal outputted by the read element is evaluated.

### BACKGROUND OF THE INVENTION

1. Field of the Invention

The present invention relates to a method of testing a magnetic head used in a magnetic storage apparatus such as a magnetic disk apparatus, and in particular to a method of testing a magnetic head to evaluate, via a simple simulation, the characteristics of a read element when affected by noise due to external electrical waves and/or an electric field.

2. Related Art

Electronic appliances normally malfunction and are unable to operate when affected by noise due to strong external electrical waves and/or an electric field (hereinafter also referred to as “external noise”). Accordingly, appliances are constructed so as to be shielded or earthed to make them more resistant to the effects of external noise.

In a magnetic storage apparatus, the magnetic head in particular is easily affected by external noise. For example, there are cases where induced noise is produced in an output signal of the read element due to the effects of external noise, which can cause read errors.

A typical method of measuring the resistance of an electronic appliance to external noise is an immunity test where the electronic appliance is placed inside an electromagnetic shield room, electrical waves of a predetermined frequency range are emitted inside the electromagnetic shield room, and the operation of the electronic appliance in the resulting electric field is checked.

Patent Document 1 discloses a technique where a leaked magnetic field is applied to a magnetoresistance effect element (i.e., the read element) by supplying a high-frequency current to a magnetic induction element (i.e., the write element) of a magnetic head and measuring the resistance change characteristics of the magnetoresistance effect element in response to an external electric field and the leaked magnetic field.

That is, a high-frequency current is applied to the magnetic induction element via input terminals of the magnetic induction element to cause the write coil of the magnetic induction element to produce a magnetic field and the effects of such magnetic field on the magnetoresistance effect element are tested.

### Patent Document 1

Japanese Laid-Open Patent Publication No. H08-329431 (Paragraphs 0009 to 0011)

### SUMMARY OF THE INVENTION

Among magnetic heads of the same product type, there are fluctuations in the resistance to external noise, with a certain proportion of the heads having extremely low resistance to noise.

To sort out such magnetic heads with low resistance to noise, it would be conceivably possible to carry out the immunity test for external noise described above on individual magnetic heads (i.e., to test every head). However, the conventional immunity test for external noise has the following problems.

The conventional immunity test is carried out to evaluate a number of samples used for monitoring, and there are the problems that an electromagnetic shield room needs to be provided and a large number of processes, such as measurement preparations (for example, shielding the test apparatus) and measurement itself need to be carried out.

This means that it is unrealistic to subject every magnetic head to the conventional immunity test, which makes it difficult to quickly discover magnetic heads with superior or inferior resistance to noise and also to quickly feedback the test results into the manufacturing process.

Also, during the conventional immunity test, external noise is also applied to the test apparatus used to detect the output signal of the read element of the magnetic head. Induced noise generated from the test apparatus due to the effects of such external noise is superimposed on the output signal of the read element, which makes it difficult to correctly measure only the noise generated from the read element.

In the technique disclosed in Patent Document 1, since the read element is tested in a state where a high-frequency current is supplied to the write coil of the write element, that is, in a state where magnetic flux is generated from the main magnetic pole of the write element, in reality it is also difficult to read a magnetic signal from the magnetic recording medium using the read element and test the read characteristics.

In the technique disclosed in Patent Document 1, since a strong magnetic field acts upon the read element from the write coil, it is not possible to test the effects of only electrical waves and an electric field on the read element.

The present invention was conceived to solve the problems described above, and it is an object of the present invention to provide a method of testing a magnetic head that causes noise due to electrical waves and an electric field to act on a read element and tests an output signal of the read element while making it possible to have the read element actually read a magnetic signal recorded on a magnetic recording medium, where no special equipment is required, where it is possible to suppress the number of processes and cost of the test and test preparation, and where it is also possible to correctly measure the output signal of the read element with hardly any effect on a testing apparatus for testing the output signal of the read element.

To achieve the stated object, the method of testing a magnetic head according to the present invention tests a magnetic head including a read element, a write element, and a predetermined electrical circuit and includes steps of: applying an AC voltage to the electrical circuit; and evaluating an output signal of the read element in a state where the AC voltage is applied.

By doing so, it is possible to evaluate noise in the output signal of the read element due to a voltage induced in the read element by noise caused by electrical waves and an electric field (i.e., simulated external noise) produced by the AC voltage. Also, since write noise from the write element is not produced as with the technique disclosed in Patent Document 1, the read element can be tested in a state where a magnetic signal recorded on the magnetic recording medium is actually read. Also, unlike the conventional immunity test, a device for generating an AC voltage is sufficient and no special equipment is required, and it is possible to suppress the number of processes and the cost of the test and test preparation. In addition, since external noise does not act on the testing apparatus itself, it is possible to correctly measure the output signal of the read element.

In addition, in the state where the AC voltage is applied to the electrical circuit, a magnetic signal may be written on a magnetic recording medium by the write element, the written magnetic signal may be read by the read element, and the output signal of the read element may be evaluated.

By doing so, it is possible to test the read/write characteristics in a state where noise due to electrical waves and an electric field act on the magnetic head.

Also, a signal level of a component included in the output signal that has a same frequency as a frequency of the AC voltage may be detected and the detected signal level may be evaluated as a level of induced noise due to the electrical waves and the electric field.

By doing so, it is possible to extract, from the output signal, noise effects (induced noise) of electrical waves and an electric field at a specified frequency.

Also, variation in the characteristics of the read element due to the electrical waves and the electric field may be evaluated by reading, before the AC current is applied to the electrical circuit, a magnetic signal on a magnetic recording medium using the read element and storing a first normal output signal outputted by the read element in a storage means, then reading, after the output signal of the read element has been evaluated in the state where the AC voltage is applied to the electrical circuit, the magnetic signal on the magnetic recording medium using the read element in a state where no AC voltage is applied to the electrical circuit and storing a second normal output signal outputted from the read element in the storage means, and comparing the first normal output signal and the second normal output signal stored in the storage means.

By doing so, it is possible to evaluate variation in the characteristics of the read element due to the effects of the electrical waves and the electric field on the read element.

The electrical circuit may be a different electrical circuit to the circuits of the write element and the read element, such as a heater circuit used to control dynamic flying height.

By doing so, it is not necessary to add an electrical circuit or terminals to the magnetic head, and testing can be carried out using an existing heater circuit for controlling the dynamic flying height and the terminals of such heater circuit.

According to the method of testing a magnetic head according to the present invention, it is possible to cause noise due to electrical waves and an electric field to act on a read element and test an output signal of the read element while making it possible to have the read element actually read a magnetic signal recorded on a magnetic recording medium. In addition, no special equipment is required and it is possible to suppress the number of processes and the cost of the test and test preparation. In addition, since there is hardly any influence on the testing apparatus for detecting the output signal of the read element, it is possible to correctly measure the output signal of the read element.

### BRIEF DESCRIPTION OF THE DRAWINGS

FIG. 1 shows the internal construction of a magnetic disk apparatus as a magnetic storage apparatus;

FIG. 2 is a diagram useful in explaining an electrical configuration of the magnetic head and how a testing apparatus is connected;

FIG. 3 is a graph showing an AC bias voltage (AC voltage) applied to an electrical circuit; and

FIG. 4 is a graph showing measurement results for induced noise included in the output signal of the read element of the magnetic head measured by a method of testing a magnetic head according to the present invention.

### DESCRIPTION OF THE PREFERRED EMBODIMENTS

Preferred embodiments of a method of testing a magnetic head according to the present invention will now be described.

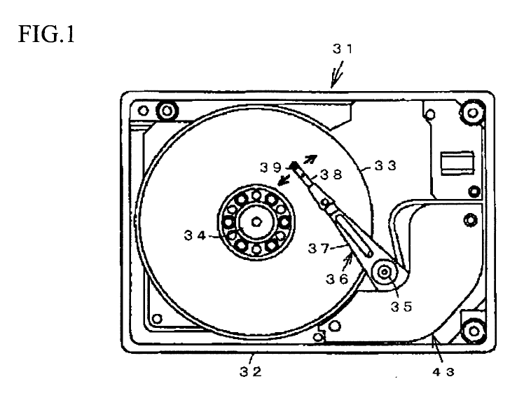

FIG. 1 shows the internal construction of a magnetic disk apparatus 31 as a magnetic storage apparatus that includes a magnetic head to be tested by a method of testing a magnetic head according to the present embodiment. A magnetic disk 33 as a magnetic recording medium is enclosed in a main body 32 of the magnetic disk apparatus 31 that is formed as a rectangular box. The magnetic disk 33 is mounted on a rotational shaft of a spindle motor 34 and is rotated by driving the spindle motor 34.

A carriage 36 that swings about a support shaft 35 that extends in a direction perpendicular to a disk surface of the magnetic disk 33 is enclosed inside the main body 32. The carriage 36 includes a rigid swing arm 37 that extends horizontally from the support shaft 35 and an elastic suspension 38 that is attached to a front end of the swing arm 37 and extends forward from the swing arm 37.

A slider 39 is attached to the front end of the elastic suspension 38 so that a flying surface thereof faces the disk surface of the magnetic disk 33.

A pressing force due to the elastic suspension 38 presses the slider 39 toward the surface of the magnetic disk 33. The movement of air flows produced at the surface of the magnetic disk 33 when the magnetic disk 33 rotates causes lift to act on the slider 39. Due to the balance between the pressing force of the elastic suspension 38 and the lift, the slider 39 flies during rotation of the magnetic disk 33.

When the slider 39 is flying, the carriage 36 swings about the support shaft 35 so that the slider 39 moves across the surface of the magnetic disk 33 in the radial direction. By moving in this way, the slider 39 is positioned at a desired recording track on the magnetic disk 33. The swinging of the carriage 36 is realized by an actuator 43 called a voice coil motor (VCM), for example.

A magnetic head including a read element and a write element is provided on the flying surface side of the slider 39.

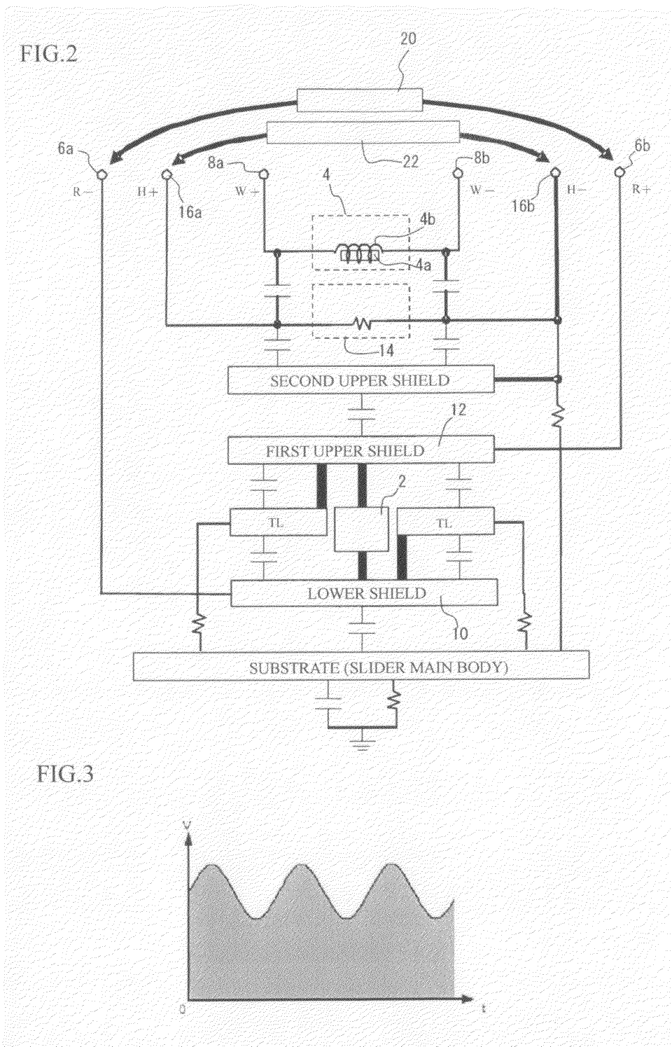

FIG. 2 is a diagram useful in explaining the electrical configuration of a representative magnetic head provided on the slider 39.

The magnetic head includes a read element 2 and a write element 4.

The read element 2 is provided between a lower shield 10 and a first upper shield 12. The lower shield 10 is connected to an external terminal 6a and the first upper shield 12 is connected to an external terminal 6b.

A magnetic signal recorded on the magnetic disk 33 is read by the read element 2 by applying a bias voltage between the lower shield 10 and the first upper shield 12 via the external terminal 6a and the external terminal 6b and detecting changes in the electrical resistance of the read element 2 in accordance with the magnetic signal on the magnetic disk 33 by detecting the voltage between the external terminal 6a and the external terminal 6b.

The write element 4 includes a main magnetic pole 4a and a write coil 4b that is wound around part of the main magnetic pole 4a. The write coil 4b is connected to external terminals 8a, 8b.

A magnetic signal is written on the magnetic disk 33 by the write element 4 by applying a predetermined current signal to the write coil 4b via the external terminals 8a, 8b to generate magnetic flux from the main magnetic pole 4a and causing such magnetic flux to act upon the recording surface of the magnetic disk 33.

Aside from the read element 2 and the write element 4, the magnetic head is equipped with a heater circuit 14 for controlling the dynamic flying height (DFH) as a predetermined electrical circuit. The heater circuit 14 is composed of a resistance circuit as an electric heater and is connected to external terminals 16a, 16b.

By supplying current to the heater circuit 14 via the external terminals 16a, 16b, the heater circuit 14 is heated, which heats the slider 39 to cause expansion and deformation. The term “dynamic flying height” refers to a technique where the air flow between the magnetic disk 33 and the slider 39 is changed due to deformation of the slider 39 so as to control the flying height of the slider 39 above the magnetic disk 33.

Note that although capacitor symbols are shown in FIG. 2, the respective elements of the magnetic head are formed by laminating thin films and the symbols show that a capacitor function is produced between the respective elements (i.e., this diagram does not necessarily mean that capacitance circuits are provided).

An embodiment of a method of testing the magnetic head described above will now be described.

First, an output signal measuring device 20 that measures the output signal (i.e., a signal where the voltage between the external terminals 6a, 6b changes in accordance with changes in the electrical resistance of the read element 2) outputted by the read element is connected to the external terminals 6a, 6b connected to the read element 2.

Also, an AC bias voltage generating device 22 as an AC voltage generating device that generates an AC bias voltage as an AC voltage is connected to the external terminals 16a, 16b connected to the heater circuit 14.

Note that connecting to the external terminals 6a, 6b, 16a, 16b may be carried out by placing a probe in direct contact with external terminals provided on the slider 39 or by connecting to a wiring pattern of a flexible circuit board that extends from the slider 39 onto the elastic suspension 38 and the swing arm 37 and is connected to the external terminals 6a, 6b, 16a, 16b.

Next, by reading a predetermined magnetic signal recorded in advance on the magnetic disk 33 using the read element 2, data showing a first normal output signal outputted by the read element 2 is detected by the output signal measuring device 20 and stored in a storage means (a memory, hard disk drive, or the like) of the output signal measuring device 20.

Next, an AC bias voltage is applied by the AC bias voltage generating device 22 via the external terminals 16a, 16b to the heater circuit 14. As shown in FIG. 3, the term “AC bias voltage” is a voltage signal where the voltage cyclically changes and where the center value of the voltage is positively or negatively biased by a predetermined amount. Note that the expression “AC voltage” for the present invention is not limited to an AC bias voltage and provided that there is no electrical harm to the circuit, the AC voltage may be a simple AC voltage whose voltage value cyclically changes between negative and positive.

In a state where electrical waves and electrical noise induced by applying the AC bias voltage to the heater circuit 14 act on the read element 2, a magnetic signal on the magnetic disk 33 is read by the read element 2 and data showing the output signal outputted by the read element 2 is detected by the output signal measuring device 20 and stored in the storage means (a memory, hard disk drive, or the like) of the output signal measuring device 20.

Next, in a state where the application of the AC bias voltage by the AC bias voltage generating device 22 is stopped, the magnetic signal on the magnetic disk 33 is read again by the read element 2 in the same way, so that data showing a second normal output signal outputted from the read element 2 is stored in the storage means of the output signal measuring device 20.

Note that during the read tests described above, the frequency of the AC bias voltage is changed so that the output signal of the read element 2 can be detected for different frequencies. For example, the frequency of the AC bias voltage may be changed in increments of 10 MHz from 10 to 1000 MHz and the output signal of the read element 2 at each frequency may be detected.

During such read tests carried out on the read element 2, in addition to reading a magnetic signal recorded in advance on the magnetic disk 33, it is also possible to apply a predetermined recording signal to the write element 4 via the external terminals 8a, 8b to record a magnetic signal on the magnetic disk 33, to read such recorded magnetic signal using the read element 2, and to detect the output signal outputted by the read element 2.

Next, the data showing the respective output signals stored in the storage unit is analyzed.

First, the output signal in the state where the electrical waves and the electric field act on the read element 2 (i.e., the state where the AC bias voltage is applied to the heater circuit 14) is analyzed. More specifically, the signal level of a component included in the output signal that has the same frequency as the frequency of the applied AC bias voltage is detected, and the detected signal level is evaluated as the level of the induced noise caused by the electrical waves and the electric field.

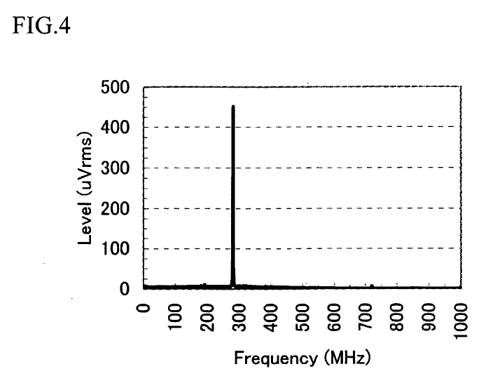

FIG. 4 is a graph showing the measurement results of induced noise included in the output signal of the read element of a given magnetic head according to the method described above. The horizontal axis of this graph shows the frequency (in units of MHz) of the applied AC bias voltage (i.e., the electrical waves and electric field that act on the read element 2) and the vertical axis shows the level of induced noise (i.e., the output noise voltage, in units of uVrms). The graph shown in FIG. 4 is an example where induced noise superimposed on the output signal was measured when an AC bias voltage (i.e., electrical waves and electric field noise) of 280 MHz was applied.

In addition, by comparing the data showing the first normal output signal and the data showing the second normal output signal stored in the storage means, variation in the characteristics of the read element 2 due to the electrical waves and electric field is evaluated.

By doing so, it is possible to evaluate variation in the characteristics (i.e., deterioration in the characteristics) of the read element 2 due to the effects of the electrical waves and electric field on the read element 2.

According to the method of testing a magnetic head according to the present embodiment, in a state where the read element 2 is actually reading a magnetic signal on the magnetic disk 33, noise due to induced electrical waves and an electrical noise field (i.e., simulated external noise) can be caused to act upon the read element 2 from the electrical circuit described above due to the AC bias voltage. Note that the present invention is not limited to testing in a state where the read element is reading a magnetic signal on the magnetic recording medium, and as another example, it is possible to use a construction where only the noise in the output signal of the read element due to the AC voltage is measured in a state where no read is being carried out. The method of testing a magnetic head according to the present invention can test an individual magnetic head or a magnetic head that has been installed in a magnetic storage apparatus (for example, a magnetic disk apparatus).

Also, according to the method of testing a magnetic head according to the present embodiment, unlike the conventional immunity test, a device for generating the AC bias voltage is sufficient and no special equipment is required, and it is possible to suppress the number of processes and the cost of the test and test preparation. In addition, since external noise does not act on the testing apparatus itself, it is possible to correctly measure the output signal of the read element 2.

In this way, since no special equipment is required and it is possible to suppress the number of processes and cost of the test and test preparation compared to the conventional immunity test, it is easy to implement the testing of every magnetic head. Magnetic heads with superior or inferior resistance to noise can also be quickly found and the test results can be quickly fed back into the manufacturing process.

If the existing heater circuit 14 for controlling dynamic flying height is used as the electrical circuit to which the AC voltage (AC bias voltage) is to be applied, it is not necessary to add an electrical circuit or terminals to the magnetic head.

However, the electrical circuit to which the AC voltage (AC bias voltage) is applied is not limited to a heater circuit for controlling dynamic flying height, and it is possible to separately provide a special-purpose electrical circuit or to use another existing electrical circuit provided in the magnetic head.

So long as electrical waves and an electric field are generated when an AC voltage (AC bias voltage) is applied, there are no particular limitations on the electrical circuit, and it is possible to use a resistance circuit, for example.

What is claimed is:

1. A method of testing a magnetic head including a read element, a write element, and a predetermined electrical circuit, the method comprising steps of:
applying an AC voltage to the electrical circuit; and
evaluating an output signal of the read element in a state where the AC voltage is applied.

2. A method of testing a magnetic head according to claim 1, wherein in the state where the AC voltage is applied to the electrical circuit, a magnetic signal is written on a magnetic recording medium by the write element, the written magnetic signal is read by the read element, and the output signal of the read element is evaluated.

3. A method of testing a magnetic head according to claim 1, wherein a signal level of a component included in the output signal that has a same frequency as a frequency of the AC voltage is detected and the detected signal level is evaluated as a level of induced noise due to electrical waves and an electric field.

4. A method of testing a magnetic head according to claim 2, wherein a signal level of a component included in the output signal that has a same frequency as a frequency of the AC voltage is detected and the detected signal level is evaluated as a level of induced noise due to electrical waves and an electric field.

5. A method of testing a magnetic head according to claim 1,
wherein before the AC current is applied to the electrical circuit, a magnetic signal on a magnetic recording medium is read by the read element and a first normal output signal outputted by the read element is stored in a storage means,
after the output signal of the read element has been evaluated in the state where the AC voltage is applied to the electrical circuit, the magnetic signal on the magnetic recording medium is read by the read element in a state where no AC voltage is applied to the electrical circuit and a second normal output signal outputted from the read element is stored in the storage means, and
the first normal output signal and the second normal output signal stored in the storage means are compared.

6. A method of testing a magnetic head according to claim 1,
wherein the electrical circuit is a heater circuit used to control a dynamic flying height.

7. A method of testing a magnetic head according to claim 5,
wherein the electrical circuit is a heater circuit used to control a dynamic flying height.
